(19) United States
(12) Patent Application Publication
(10) Pub. No.: US 2012/0050932 A1
(43) Pub. Date: Mar. 1, 2012

(54) Switch, In Particular Circuit Breaker For Low Voltages, And Power Supply For An Electronic Tripping Unit Of A Switch

(75) Inventors: Josef Götz, Freudenberg-Aschach (DE); Thomas Kiendl, Wernberg-Koblitz (DE); Richard Schmidt, Baiersdorf (DE); Jörg Weiss, Chemnitz (DE)

(73) Assignee: SIEMENS AKTIENGESELLSCHAFT, Munich (DE)

(21) Appl. No.: 13/217,387

(22) Filed: Aug. 25, 2011

(30) Foreign Application Priority Data
Aug. 26, 2010 (DE) 10 2010 036 079.1

(51) Int. Cl. H02H 3/08

(52) U.S. Cl. 361/93.6

(57) ABSTRACT

A switch is disclosed, in particular a circuit breaker for low voltages. In at least one embodiment, the switch includes a conductor, an electronic tripping unit (ETU) which trips the switch when a current limit value is exceeded, the power supply of the electronic tripping unit including current transformers, with a first winding which is connected to the electronic tripping unit (ETU) forming the secondary side of the current transformer and the conductor forming the first primary side of the current transformer, the conductor supplying electrical power to the current transformer when the current varies over time. In order to ensure power is supplied to the tripping unit (ETU) even in modes of operation in which too little power is provided by the first winding, for example in the case of a direct current, small alternating currents, a pulsed direct current etc., a second winding which forms the second primary side of the current transformer is arranged on the current transformer in addition to the first winding, and a converter (DAW) taps off a voltage from at least two conductors when there is too little power, and supplies electrical power to the second winding and therefore also to the electronic tripping unit via the secondary winding.

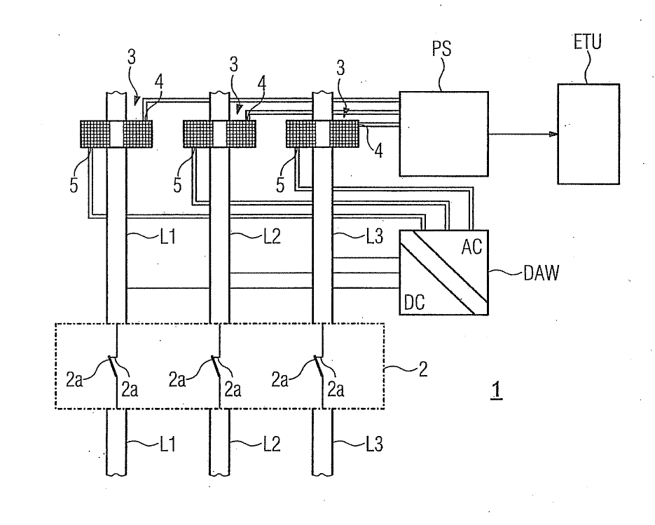

### PRIORITY STATEMENT

The present application hereby claims priority under 35 U.S.C. §119 on German patent application number DE 10 2010 036 079.1 filed Aug. 26, 2010, the entire contents of which are hereby incorporated herein by reference.

### FIELD

At least one embodiment of the invention generally relates to a switch, in particular a circuit breaker for low voltages, and/or to a power supply for an electronic tripping unit of a switch.

### BACKGROUND

Switches, in particular circuit breakers for low voltages, are known and are connected to at least one load at the load end. In the case of AC operation, an alternating current flows through the current conductor which runs through the switch, via contact elements in the form of contact pieces which bear one against the other when the switch is closed. The contact pieces are separated from one another for the purpose of opening the switch. An electronic tripping unit which is arranged in the switch monitors the current flow and triggers the separation of the contact pieces when a prespecified current limit value is exceeded. The current limit value is exceeded both in the case of an overcurrent and in the case of a short circuit current.

Power is supplied to the electronic tripping unit by way of a transformer-based current transformer having a core which is composed of a ferromagnetic material and has a primary winding and a secondary winding, with the primary winding being formed by the conductor. The secondary winding is, for its part, connected to the tripping unit by way of a rectifier circuit. The current transformer therefore supplies electrical power to the electronic tripping unit when the current through the conductor varies over time, that is to say in particular in the case of an alternating current.

Since the current also varies over time in the event of a short circuit, the transformer-based current transformer takes over the task of supplying power in this case too, irrespective of whether the short circuit occurs during DC operation or AC operation.

It goes without saying that power can also be supplied independently of the flow of current by way of an energy storage device, for example a capacitor or a battery.

One disadvantage is that in the case of DC operation in the region of the rated current and in the case of an overcurrent, there has to be a second power supply for the electronic tripping unit in each case. The transformer-based principle of the current transformer does not allow power to be supplied in the case of a direct current, that is to say in each case in the steady state after the switch-on process. The known recovery of power from the applied voltage is not quick enough during the switch-on process. In the event of a short circuit, a very low voltage which can be close to zero is applied to the load or to the switch, and therefore a voltage tap does not constitute a solution in this case either.

### SUMMARY

At least one embodiment of the invention ensures power is supplied to the tripping unit even in the case of DC operation in the region of the rated current, the overcurrent and in the event of a short circuit.

With respect to the switch, a converter is provided, the converter tapping off a voltage from a pair of conductors when required, that is to say when there is too little electrical power, and additionally supplying electrical power to the second winding. In other words, a current transformer is used for supplying power, the current transformer comprising a second winding (on the core) which is provided in addition to the first winding and which forms the second primary side of the current transformer. If too little power reaches the power supply from the first winding, a voltage is tapped off from a pair of conductors and the power tapped off in the process is fed to the second winding in the form of an alternating current.

First the first winding and then the second winding are expediently wound around a core of the current transformer during production of the current transformer.

### BRIEF DESCRIPTION OF THE DRAWINGS

An embodiment of the invention will be described in greater detail in the text which follows with reference to a drawing in which the single FIGURE shows a three-pole circuit breaker having an electronic tripping unit ETU for low voltages, called switch 1 for short in the text which follows.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the FIGURES.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGURES. For example, two FIGURES shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the FIGURES. It will be understood that the spatially relative terms are intended to encompass different orientations of the device in use or operation in addition to the orientation depicted in the FIGURES. For example, if the device in the FIGURES is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

An embodiment of the invention will be described in greater detail in the text which follows with reference to a drawing in which the single FIGURE shows a three-pole circuit breaker having an electronic tripping unit ETU for low voltages, called switch 1 for short in the text which follows. The current conductors L1, L2, L3 of the three poles run through the switch 1 and an alternating current flows through the current conductors as primary current in the case of AC operation and a direct current flows through the current conductors as primary current in the case of DC operation. When the contacts 2 of the switch 1 are closed—as shown in the FIGURE—the primary currents flow via contact pieces 2a (contact elements) which bear one against the other and are separated from one another for the purpose of opening the switch 1.

Transformer-based current transformers 3, the first primary winding (first primary side) of said current transformer forming the conductors L1, L2, L3, serve to supply power to the electronic tripping unit ETU. The secondary winding 4 (secondary side) provides the power supply PS of the tripping unit ETU with the respectively required electrical power when the primary current varies over time by at least one of the conductors L1, L2, L3, that is to say in the case of AC operation or when a short circuit current flows through at least one of the conductors L1, L2, L3 since even the occurrence of a short circuit current is associated with a change in current over time.

For modes of operation in which too little power is delivered by the secondary winding 4, that is to say, for example, in the case of direct currents (mode of operation), pulsed direct currents or small primary currents, a second primary winding 5 (second primary side) is provided, this second primary winding being wound onto the secondary winding 4 around the core of the current transformer. The winding 5 is fed with an alternating current by way of a converter DAW (DC/AC converter or AC/AC converter) and therefore the electronic tripping unit ETU is supplied with power via the secondary winding 4. In this case, the electrical power is drawn via a voltage tap between the conductors and converted into an alternating current by the converter DAW.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A switch, comprising:
a conductor, to run through the switch and through which current will flow;
contact elements, each of the contact elements bearing one against another when the switch is closed, and each of the contact elements being separated from one another for the purpose of opening the switch;
an electronic tripping unit (ETU) to trigger separation of the contact elements when a current limit value is exceeded, the ETU including a power supply, the power supply including a transformer-based current transformer arranged on the conductor, a first winding of the transformer-based current transformer, connected to the ETU, forming the secondary side of the transformer-based current transformer and the conductor forming the first primary side of the transformer-based current transformer, the conductor supplying electrical power to the ETU via the transformer-based current transformer when the current varies over time, the power supply being fed by the transformer-based current transformer, a second winding of the transformer-based current transformer, forming a second primary side of the current transformer, being arranged on a core of the transformer-based current transformer in addition to the first winding, and a converter being provided, the converter tapping off a voltage from the conductor when power is demanded and additionally supplying electrical power to the second winding.

2. The switch as claimed in claim 1, wherein the current transformer includes a core on which the first winding and the second winding are wound.

3. A power supply for an electronic tripping unit (ETU) of a switch, through which a conductor runs, a current flowing through the conductor, contact elements of the switch bearing one against another when the switch is closed and being separated from one another for the purpose of opening the switch, and the ETU triggering separation of the contact elements when a current limit value is exceeded, the power supply comprising:
a transformer-based current transformer, arranged on the conductor, a first winding of the transformer-based current transformer being connected to the ETU and forming a secondary side of the transformer-based current transformer, and the conductor forming a first primary side of the transformer-based current transformer, the conductor supplying electrical power to the current transformer when the current varies over time, a second winding, forming the second primary side of the transformer-based current transformer when the current does not vary over time, being provided in addition to the first winding, and the converter being provided, the converter tapping off a voltage from the conductor when power is demanded and supplying electrical power to the second winding.

4. The switch of claim 1, wherein the switch is a circuit breaker for low voltages.

5. The switch of claim 1, wherein the ETU triggers separation of the contact elements when a current limit value is exceeded in the case of at least one of an overcurrent and a short circuit current.

6. The power supply of claim 3, wherein the switch is a circuit breaker for low voltages.

7. The power supply of claim 3, wherein the ETU triggers separation of the contact elements when a current limit value is exceeded in the case of at least one of an overcurrent and a short circuit current.
